(19) United States
(12) Patent Application Publication
(10) Pub. No.: US 2010/0328741 A1
(43) Pub. Date: Dec. 30, 2010

(54) HOLOGRAPHIC DEVICE

(75) Inventors: Mark Allen Cheverton, Mechanicville, NY (US); Moitreyee Sinha, Niskayuna, NY (US); Brian Lee Lawrence, Niskayuna, NY (US); Sumeet Jain, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/491,357

(22) Filed: Jun. 25, 2009

(51) Int. Cl. G03H 1/28; G03H 1/00; G03H 1/26

(52) U.S. Cl. 359/2

(57) ABSTRACT

A device comprising an authentication hologram recorded within a defined volume of a holographic recording medium, wherein the authentication hologram is configured to convey authentication information; wherein the authentication hologram comprises a plurality of related volumetric holograms recorded within the defined volume; and wherein the holographic recording medium comprises an optically transparent plastic material and a photochemically active dye. In one embodiment, all the holograms are identical. In one embodiment, the holograms are different.

### BACKGROUND

The invention relates generally to the field of holographic devices. In particular, the invention relates to devices that incorporate volume holograms, particularly for purposes of security and authentication.

Holograms are becoming an increasingly popular mechanism as an anti-counterfeiting tool for brand protection and for the authentication of genuine articles. The use of holograms for this purpose is driven primarily by the relative difficulty with which they can be duplicated. Typically, volume holograms are created by interfering two coherent beams of light, to create an interference pattern and storing the resultant pattern in the volume of a holographic recording medium. Information or imagery can be stored in a hologram by imparting the data or image to one of the two coherent beams prior to their interference. The hologram can be read out by illuminating it with beams matching either of the two original beams used to create the hologram and any data or images stored in the hologram will be displayed. Complex holograms generated as a result of these complex methods are typically used for authentication of articles, for example, credit cards, software, and clothing.

However, most of these complex holograms are not directly viewable by an observer, and may require a hologram reader to read the holograms. Thus authenticating these holograms is a relatively difficult and time consuming process. A quicker and efficient way of detecting these holograms would be to have these complex holograms directly viewable by an observer. Accordingly, there remains a need for an improved solution to the long-standing problem of using the anti-counterfeiting role of holograms that lies in their ability to combine authentication with easy and quick detection.

### BRIEF DESCRIPTION

In one embodiment, is provided a device comprising an authentication hologram recorded within a defined volume of a holographic recording medium, wherein the authentication hologram is configured to convey authentication information; wherein the authentication hologram comprises a plurality of related volumetric holograms recorded within the defined volume; and wherein the holographic recording medium comprises an optically transparent plastic material and a photochemically active dye.

In another embodiment is provided a method comprising the steps of providing a device comprising an authentication hologram recorded within a defined volume of a holographic recording medium, wherein the authentication hologram is configured to convey authentication information; wherein the authentication hologram comprises a plurality of related volumetric holograms recorded within the defined volume; and wherein the holographic recording medium comprises an optically transparent plastic material and a photochemically active dye.

In yet another embodiment is provided a device comprising an authentication hologram recorded within a defined volume of a holographic recording medium; wherein the authentication hologram is configured to convey authentication information; wherein the authentication hologram comprises a plurality of substantially identical volumetric holograms recorded within the defined volume; wherein the authentication hologram appears substantially identical when the device is viewed by a hologram reader from different angles; and wherein the holographic recording medium comprises an optically transparent plastic material and a photochemically active dye.

In still yet another embodiment is provided a device comprising an authentication hologram recorded within a defined volume of a holographic recording medium; wherein the authentication hologram is configured to convey authentication information; wherein the authentication hologram comprises a plurality of related volumetric holograms recorded within the defined volume; wherein the authentication hologram appears as an animated sequence of images to a stationary observer; and wherein the holographic recording medium comprises an optically transparent plastic material and a photochemically active dye.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a method for recording and reading a hologram;

FIG. 2 illustrates a method for writing and reading a hologram in accordance with certain embodiments of the present invention;

FIG. 3 illustrates a method for writing and reading a hologram in accordance with certain embodiments of the present invention;

FIG. 4 illustrates a method for writing and reading a hologram in accordance with certain embodiments of the present invention;

FIG. 5 illustrates a method for writing and reading a hologram;

FIG. 6 illustrates a method for writing and reading a hologram;

FIG. 7 illustrates a method for writing and reading a hologram;

FIG. 8 illustrates a method for writing and reading a hologram in accordance with certain embodiments of the present invention;

FIG. 9 illustrates a method for writing and reading a hologram in accordance with certain embodiments of the present invention; and

FIG. 10 illustrates a method for writing and reading a hologram in accordance with certain embodiments of the present invention.

### DETAILED DESCRIPTION

The invention relates generally to the field of holographic devices. In particular, the invention relates to devices that incorporate volume holograms, particularly for purposes of security and authentication.

Embodiments of the invention described herein address the noted shortcomings of the state of the art. The invention relates to holographic security techniques that can be incorporated into documents of value, bank notes, cards, security access systems, and product authenticity. These holographic security techniques involve writing volumetric holograms into a holographic recording medium, wherein the holographic recording medium can be injection molded, extruded, cast into films, or molded into parts. The ability to injection mold, extrude, or cast this holographic recording medium provides great flexibility in their application. In addition, because it is a volumetric hologram, the hologram may be written within the volume of the material, and has no surface structure like surface holograms. Thus rendering it increasingly difficult and relatively impossible to counterfeit these volumetric holograms without prior knowledge of the initial hologram writing conditions, for example writing conditions including but not limited to beam geometry, wavelength, power, exposure time, and reference mask and access to the holographic recording medium. These volumetric holograms may be recorded as covert holograms, overt holograms, animated holograms, micro holograms, reflection holograms, and transmission holograms. These volumetric holograms may be directly viewed by an observer or may be machine-readable holograms. These volumetric holograms may be incorporated into security cards, transaction cards, smart card (RFID card), identification cards, identification documents, holographic labels, transparent holographic overlays, holographic strips, and holographic threads. Additional security features, using phase masks or amplitude masks on the reference beam, may render the hologram more secure. Typically, as known to one skilled in the art, a single hologram on a dye-doped thermoplastic material having a thickness of about 100 micrometers, may have a view angle of +/−0.5 degrees, measured to the first destructive node on the Bragg detuning curve. The single hologram may generally not be directly viewable by an observer using normal room lights. The volumetric holograms recorded in accordance with the embodiments of the present invention are such that they are directly viewable by an observer over a larger angle of view thus improving the detectability of these holograms. Further, holograms recorded in photopolymers, photoreactive polymers, dichromated gelatins, and silver halides require post processing. The post processing may generally involve wet chemistry processing to fix the hologram after the hologram has been recorded, so that the hologram may not be erased with exposure to ambient light. The volumetric holograms recorded in accordance with the embodiments of the present invention are such that they can be viewed immediately after the hologram is recorded. Using the holographic recording medium described herein may help to either avoid or to minimize the post processing involving wet chemistry processing.

In various embodiments, hologram authentication may either be used to authenticate a device as a genuine device or authenticate the device holder as genuine owner of the device. In certain embodiments, as described in detail below, to authenticate the device the hologram may include one or more of complex images, images with animated features, images with overt features, images with covert features, and micro holograms. The complexity of the recorded image may render it extremely difficult if not impossible to counterfeit or replace with a non-genuine hologram. Further, in certain embodiments, the images used in the recording process would be specific to the application and could be changed depending on the security needed. The images could hold personalized information about the device holder or just be generic images to authenticate the device depending on when the holograms are recorded in the production process. For example, if the holographic film is to be integrated into a card or identification document, then it may be necessary to record card holder information into the holographic medium after the holographic material has been laminated into the card structure. As a result, the personalized data like facial image, name, numbers, would be recorded at the end of the manufacturing process and a personalization site. If however, the holographic film is to be integrated into a credit card, then the credit card manufacturer may want to put the same holographic image on every credit card. In this example, the holograms can be recorded before integration, by recording a generic image that are unrelated to the card holder. The pre-recorded holographic material may then be integrated into the card structure. In addition, the holographic recording medium, for example a holographic film, may be laminated into the structure of the device by either hot pressing or using pressure sensitive adhesives, so that it would be virtually impossible to remove, replace, or duplicate the hologram recorded in the film.

Further, to authenticate the device holder as genuine, the device holder's biometrics may be recorded into the holographic film. The biometrics may include their facial image, finger print, or retinal image. Each biometric may be angle multiplexed, with multiple images recorded into the film, so that statistical matching may be employed to increase the confidence of the match. To read the biometric data off the holographic recording medium, a proprietary reader would need to be used that will hold the device at the correct angle and use a specific wavelength on the read beam so that image detection may be optimized. A charge coupled device (CCD) camera may be used to capture the biometric image and store it temporarily in memory. To authenticate the device holder, a live biometric image may be captured from the device holder, and then compared against the biometric image on the device. Further, to enhance the security of the system, the biometric images recorded into the holographic recording medium may be encoded in a manner such that the image may not be read without the proper personal identification number (PIN) codes that can be entered by the device holder.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” and “the” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components unless otherwise stated. As used herein, the terms “disposed over” or “deposited over” or “disposed between” refers to both secured or disposed directly in contact with and indirectly by having intervening layers therebetween.

In one embodiment, is provided a device comprising an authentication hologram recorded within a defined volume of a holographic recording medium, wherein the authentication hologram is configured to convey authentication information; wherein the authentication hologram comprises a plurality of related volumetric holograms recorded within the defined volume; and wherein the holographic recording medium comprises an optically transparent plastic material and a photochemically active dye.

As used herein the phrase “authentication hologram” means a hologram that is affixed on an article and has features that can be identified either visually or by using a hologram reader. The features help to ascertain that the article is genuine and not counterfeit. The features may include but are not limited to two dimensional images specific to the item being authenticated, images specific to the manufacturer of the item being authenticated, holograms that flip from one image to a different image when the hologram is moved or rotated, micro images, three dimensional images, holographic serial numbers, machine readable text or numbers, one dimensional bar codes, and two dimensional bar codes. These authentication holograms could be multi-colored, color changing, or single colored. They could be visible to the naked eye, or require special light sources, fixtures, or special equipment to read/view the hologram. In various embodiments, the hologram may be in the form of an image that is macroscopic in nature or the hologram may be an image that is microscopic. As used herein the term “macroscopic” means an image that is viewable by the human eye. As used herein the term “microscopic” means an image that is not viewable to the human eye because it is very small, and would require imaging equipment like cameras, lenses, or microscopes. In various embodiments, the hologram may include one or more of a digital data, similar to a one dimensional bar code, a two dimensional bar code, an array of spots of light, and 1's and 0's. After recording these holograms, they would be read out using a single reference beam, which will reconstruct the hologram and make it viewable either to a viewer or to a hologram reader. The holographic image could include at least one of a fingerprint, a facial image, a retinal image, a security image, or a company logo. In certain embodiments, any image or information could be recorded as a hologram. In one embodiment, the device comprises a credit card, an identification card, hotel room key, an access key, a passport, a bill of currency, an authentication tag, a shipping manifest, a bill of lading, or an electronic information storage device.

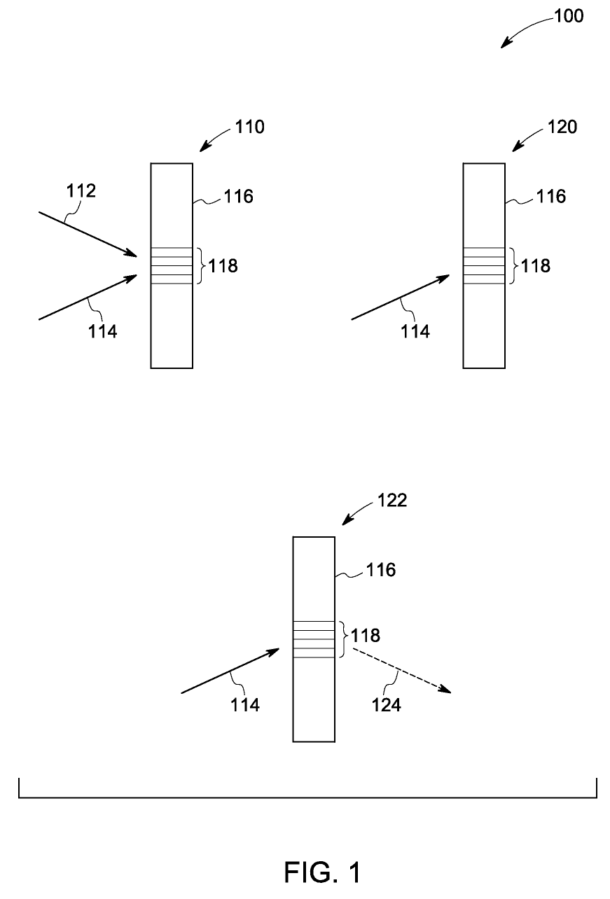

Referring to FIG. 1 a method 100 of recording 110 and reading (120,122) a hologram is provided. A signal beam 112 and a reference beam 114 are incident on a holographic recording medium 116. FIG. 1 shows the beam geometry for recording a transmission hologram (not shown in figure). When the signal beam 112 and the reference beam 114 hit the holographic recording medium 116, they will interfere and result in a refractive index change in the material that forms the holographic recording medium 116. The refractive index pattern formed within the volume of the material will create a diffraction grating 118 whose structure and optical properties will be dependent on the material that forms the holographic recording medium, laser beam profile, recording parameters, and beam geometry. To read (120, 122) the hologram after it is recorded, the signal beam 112 is turned off, and only the reference beam 114 is used to illuminate the diffraction grating 118. In one embodiment, 122 when the reference beam 114 hits the diffraction grating 118, a reconstructed signal beam 124 is observed leaving the side of the holographic recording medium 116 opposite to the side in which the signal beam 112 and the reference beam 114 are incident on the holographic recording medium 116. The reconstructed signal beam 124 that leaves the holographic recording medium 116 appears identical to the original signal beam 112. The brightness of the reconstructed signal beam 124 is determined by the diffraction efficiency of the hologram.

In one embodiment, the plurality of related volumetric holograms are substantially identical. In one embodiment, the authentication hologram appears substantially identical when the device is viewed by a hologram reader from different angles. In another embodiment, the authentication hologram appears identical when viewed by a human eye from different angles.

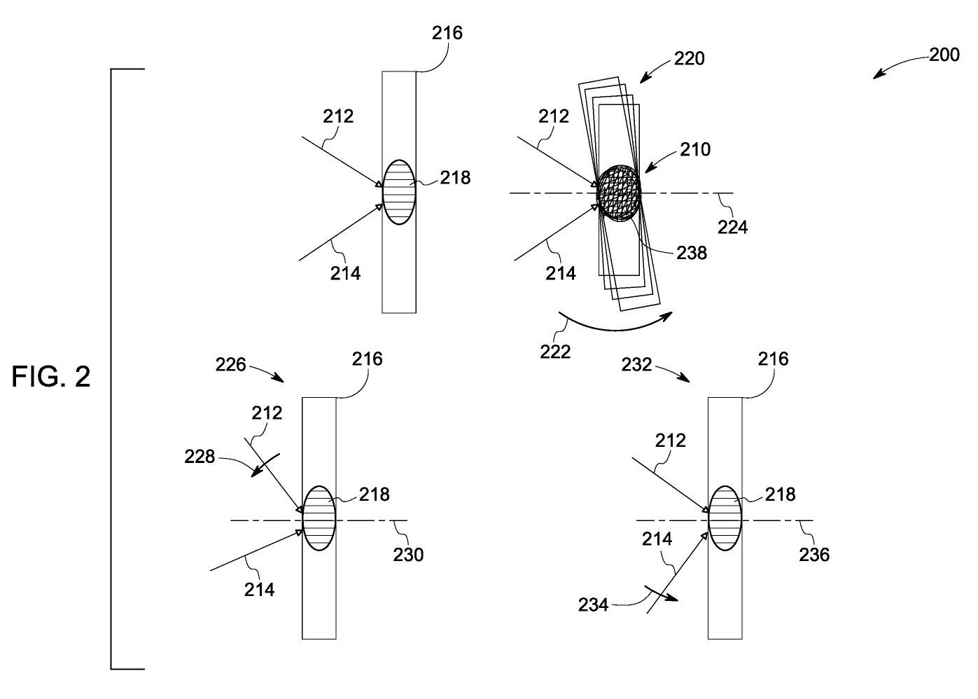

Referring to FIG. 2, a method 200 of recording a plurality of holograms 210 is provided. A signal beam 212 and a reference beam 214 are incident on a holographic recording medium 216. In a first step, a single volumetric hologram 218 is formed at the point where the signal beam 212 and the reference beam 214 interfere. The signal beam 212 and the reference beam 214 interact throughout the defined volume of the holographic medium and create the volumetric hologram 218 that fills the entire volume of the interaction region defined by the two beams at one particular angle. In a similar manner the signal beam 212 and the reference beam 214 interact throughout the defined volume of the holographic medium and create the volumetric hologram 218 that fills the entire volume of the interaction region defined by the two beams at different angles to form the plurality of holograms 210 that are angle multiplexed. In various embodiments, as described below, the holographic recording medium may be rotated, the signal beam may be rotated or the reference beam may be rotated to achieve the angle multiplexing. In one embodiment 220, as depicted in FIG. 2 the holographic recording medium 216 is rotated 222 relative to the signal beam 212 and the reference beam 214 around an axis 224. The plurality of holograms 210 are angle multiplexed in the holographic recording medium 216 in a manner such that the angle multiplexed holograms i.e., each of the plurality of holograms 210 reside directly on top of each other, each hologram filing the entire volume of the interaction region of the signal beam 212 and the reference beam 214 in the holographic recording medium 216. In another embodiment 226, as depicted in FIG. 2 the signal beam 212 is rotated 228 relative to the holographic recording medium 216 and the reference beam 214 around the axis 230. A plurality of holograms 210 are thus angle multiplexed in the holographic recording medium 216 by forming a single volumetric hologram 218 at one angle of the signal beam 112 and subsequently a plurality of volumetric holograms 210 at varying angles 228 of the signal beam 112. In yet another embodiment 232, depicted in FIG. 2 the reference beam 214 is rotated 234 relative to the holographic recording medium 216 and the signal beam 212 around the axis 236. A plurality of holograms 210 are thus multiplexed in the holographic recording medium 216 to provide angle multiplexed holograms by forming a single volumetric hologram 218 at one angle of the reference beam 114 and subsequently a plurality of volumetric holograms 210 at varying angles 234 of the reference beam 114. When the plurality of angle multiplexed holograms are recorded, they all occupy the same volume of the material, almost completely overlapping each other, though each individual hologram was recorded at a slightly different angle as described above. Each hologram can be viewed at a slightly different angle, even through all the holograms occupy the same physical volume in the holographic medium. The holograms are shown in FIG. 2 as overlapping ovals 238. Hash marks 240 are drawn on the ovals, and the hash marks 240 show the overlap of the holograms, and also indicate that each hologram is distinct and each hologram is a result of an angle multiplexed recording irrespective of whether the sample, the signal beam or the reference beam being rotated. Since identical holograms are angle multiplexed in the same volume of the holographic recording medium, the authentication hologram so formed appears substantially identical when the device is viewed by a human eye or by a hologram reader from different angles.

In one embodiment, the authentication hologram appears as an animated sequence of images to a stationary observer. In one embodiment, the animated sequence of images include a series of non-identical but related images such as for example, images of a person's face taken from different angles, and when these images are written as a hologram the stationary observer can view the person's face in a three dimensional view. In one embodiment, the authentication hologram is recorded within one or more volume elements of a holographic recording medium in a manner such that the information recorded one on top of another in the same volume element of the medium is modulated to have a relationship. The angle-multiplexed holograms discussed above can be used to increase view angle by recording the same image at different angles as discussed above, or the images can be slightly altered so that the resultant hologram appears as an animated image. The rate of the animation can be controlled by how fast the cardholder moves the card. These animated images would act as a security and authenticity feature in that they are very difficult to make and virtually impossible to duplicate. Any image could be used for this animation, and they would be specifically designed to the application.

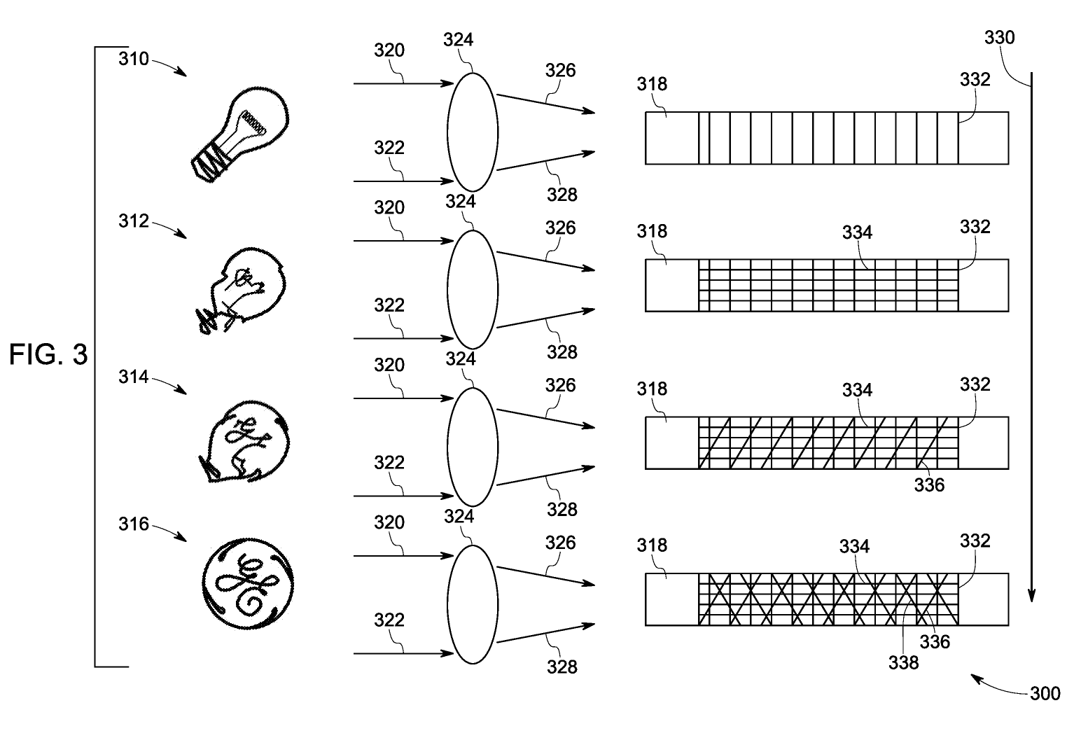

Referring to FIG. 3 a series of images 300, including individual images 310, 312, 314, and 316 are illustrated. The images 310 to 316 can be recorded using angle multiplexing as described above, into a holographic recording medium 318. Light beams 320 and 322 may be focused on the holographic recording medium using a lens 324 to focus the signal beam 326 and the reference beam 328 on the holographic recording medium 318. Each image from 310 to 316 is separately written into the holographic recording medium 318 in a sequence 330. The signal beam may independently include the images 310 to 316 as the recording is carried out in the sequence 330. When the holographic recording media is viewed the images change from 310 to 316 to provide a modulated view resulting in an animated image. Each individual image 310 to 316 is recorded separately, at a specific angle, and the individual image frames are separated by some predetermined angular spacing, to give the desired optical animated effect when viewing the animated hologram. For example, the first image 310 is first recorded at an angle 332 perpendicular to the length of the holographic recording medium. The second image 312 is then recorded at an angle 334 perpendicular to the first image 310. The third image 314 is then recorded at an angle 336 to the first image and the fourth image 316 is then recorded at an angle 338 to the first image. Animated images that smoothly change appearance from image 310 to 316 as the viewers change their viewing angle are thus recorded.

In one embodiment, at least one hologram of the plurality of related volumetric holograms is optically encoded. As used herein the phrase “optically encoded” means using a reference mask, for example, a phase mask on the reference beam during the recording process. The phase mask is used to optically encode the data or images in the holographic medium. To play back the data or read the data, the reference beam would need to include the phase mask, in order to get an undistorted reconstructed signal beam.

In one embodiment, overt images recorded into the holographic film may not be encoded, since overt images are intended to be viewable by anyone without any specific training or equipment. However, covert images, that typically include cardholder data, demographics, insurance information, medical information, biometric data, and other sensitive information are not intended to be easily viewable. The covert data could be encoded both by optical encoding as well as electronic encoding so that the data could not be read out by an unauthorized person. In one embodiment, data encoding may be achieved using a spatial light modulator (SLM), digital light processor (DLP), or a liquid crystal display (LCD) on both the reference beam and signal beam. The data may be electronically encoded using standard encryption techniques already used in the security industry, such as for example using PIN codes and data encrypting schemes. This encoded electronic data may then be sent to the SLM, DLP, or LCD on the signal beam. The SLM, DLP or LCD may allow the data to be encoded into the signal beam, and a hologram of this data may then be recorded into the holographic recording medium. Typically, in standard recording processes, the reference beam has a Gaussian or flat-top profile. To add optical encryption to this process, the Gaussian reference beam would be replaced with a structured reference beam, looking much like a two dimensional barcode array. The same structured reference beam used in the recording process is then used to read the hologram. Any deviation in the reference beam from recording to reading will cause distortion in the hologram being reconstructed. As a result, the structure of the reference beam can be related to the device holder's PIN code as well as being related to one or many of their live biometric images. If an unauthorized person were to try to read this data without the correct PIN or device holder biometric image, then the structure of the reference beam would not be correct and the reconstructed hologram would be distorted to a point where the data may not be read.

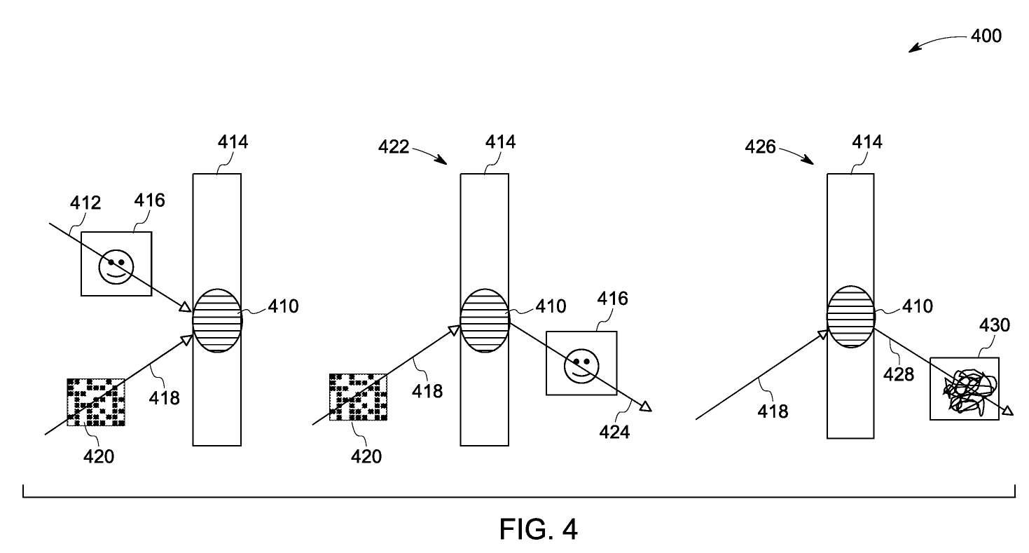

Referring to FIG. 4, a method 400 of optically encoding a hologram 410 is provided. A signal beam 412 is incident on a holographic storage medium 414. The signal beam 412 includes an image 416 which is recorded in a defined volume of the holographic storage medium 414. A reference beam 418 is also incident on the holographic storage medium 414. The reference beam 418 includes a phase mask 420 which is also recorded in the defined volume of the holographic storage medium 414. The phase mask 420 is recorded in the holographic storage medium 414 in a manner such that to play back the hologram, the reference beam 418 used to read the image 416 would need to include the phase mask 420. In one embodiment 422, as depicted in FIG. 4, the reference beam 418 used to read the hologram 410 includes a phase mask 420 and the image 416 is played back 424 without any distortion. In another embodiment 426, as depicted in FIG. 4, the reference beam 418 used to read the hologram 410 does not include a phase mask 420 and the hologram 410 is not played back 428 properly and the playback image is distorted 430.

In one embodiment, the optically encoded data could include digital data obtained by converting the above mentioned images to digital form using encoding schemes, such as for example, the Manchester encoding method. This encoded data may then be recorded into the holographic material, and read out either by an observer or a hologram reader. In various embodiments, the phase mask 420 can be a series of transparent and opaque sections. In one embodiment, the phase mask used in the optical encoding may include a fixed mask, one dimensional bar code, two dimensional bar code, an image, or a fixed optical structure. In another embodiment, the phase mask can also be a biometric image of a person like a facial image, a retinal scan image, an iris scan image, or a fingerprint.

In various embodiments, the holograms may either be recorded into the holographic recording medium before being included into a device, or it could be recorded into the holographic recording medium after being included into the device. Typically reflection holograms have a different visual appearance, only showing the recording wavelength (single color) while the transmission holograms show the entire visible spectrum when viewed. For viewing a transmission hologram there must either be a transparent window in the device, or a reflective surface behind the hologram. The choice of which beam is used as the signal beam and which beam is used as the reference beam is determined by whether the hologram will be viewed in transmission mode or in reflection mode.

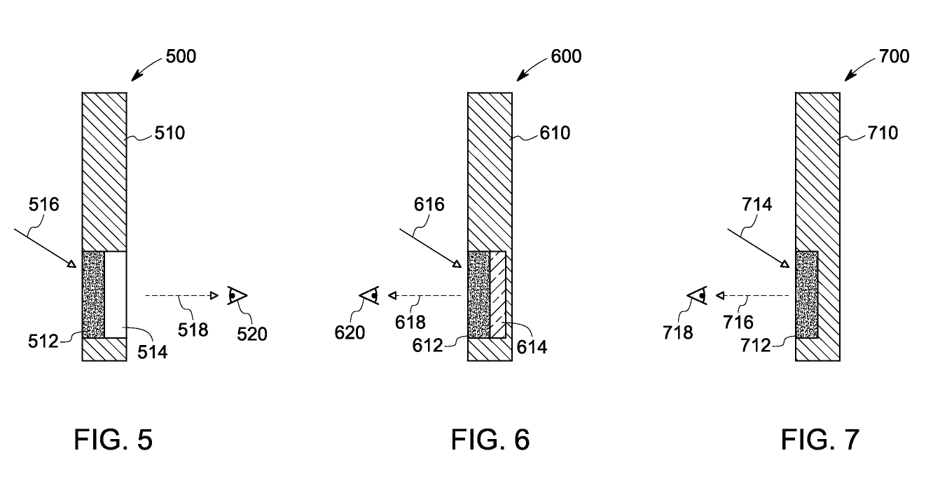

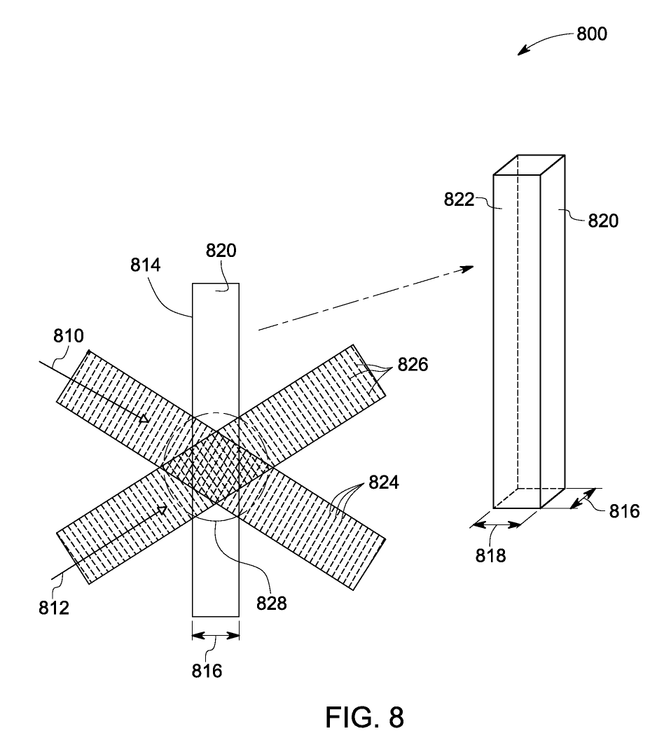

Referring to FIG. 5, a method 500 of viewing a transmission hologram in transmission is provided. A holographic recording medium 510 includes a hologram 512 and a transparent window 514. A reference beam 516 is incident on the hologram and the reconstructed signal beam 518 emerging from the transparent window is viewed by an observer 520. The reference beam 516 and the reconstructed signal beam 518 are on opposite side of the holographic recording medium. Referring to FIG. 6, a method 600 of viewing a transmission hologram in reflection is provided. A holographic recording medium 610 includes a hologram 612 and a reflective foil 614. A reference beam 616 is incident on the hologram and the reconstructed signal beam 618 emerging after reflection at the reflection foil is viewed by an observer 620. The reference beam 616 and the reconstructed signal beam 618 are on the same side of the holographic recording medium. The presence of the reflective foil 614 is necessary for viewing the transmission hologram in reflection which takes away the need for a transparent window in the device. Referring to FIG. 7, a method 700 of viewing a reflection hologram in reflection is provided. A holographic recording medium 710 includes a hologram 712. A reference beam 714 is incident on the hologram and the reconstructed signal beam 716 emerging from hologram location is viewed by an observer 718. The reference beam 714 and the reconstructed signal beam 716 are on the same side of the holographic recording medium.

In various embodiments, if the holograms were to be recorded after the holographic recording medium is included in the device, then the transparent window would be required for reflection hologram recording since the reflection holograms require the two beams of light to be incident on the holographic film from opposite sides. For recording transmission holograms after the holographic recording medium is included in the device, no transparent window is needed to record the hologram, however either a transparent window or reflective foil layer would be necessary to view the hologram. In one embodiment, the hologram may be recorded with the reflective foil layer behind the holographic film, so that it can be recorded with the film in the card structure and viewed.

In various embodiments, the optimal thickness of the holographic recording medium is dependent on the application. In one embodiment, the hologram is a covert hologram. Generally a covert hologram, is relatively difficult to locate using normal room lights since a covert hologram is not intended to be viewable to the general public, but is typically used as a forensic. Typically, a covert hologram requires a special light, or a special fixture to hold the holographic film at a specific angle, or require the use of a laser with a specific wavelength to view the hologram, or a camera to capture an image of the hologram, or all of the above. The covert hologram could require the use of a hologram reader, a system that would take the device from the device holder, for example the device could be a card and the device holder an ATM, and read the hologram with a CCD camera and laser.

In one embodiment, wherein the holographic recording medium is used for covert applications, a large view angle may be achieved by recording multiple identical holograms with small angular displacements (angle multiplexing) in the holographic recording medium. Angle multiplexing of holograms renders holograms recorded in thicker films to be easily visible and easy to locate on the holographic recording medium. In one embodiment, the thickness of the holographic recording medium used for covert applications is in a range of about 5 micrometers to about 1200 micrometers. In another embodiment, the thickness of the holographic recording medium used for covert applications is in a range of about 30 micrometers to about 800 micrometers. In yet another embodiment, the thickness of the holographic recording medium used for covert applications is in a range of about 50 micrometers to about 500 micrometers.

For example, if about 50 identical holograms, each separated by an angle of about 0.3 degrees are recorded in a holographic recording medium having a thickness of about 200 micrometers, the view angle may be increased from about +/−0.5 degrees for a single hologram to about +/−7.5 degrees for 50 angle multiplexed holograms and the hologram may be easily viewable with the unaided eye. As the cardholder rotates the card, they will view each of these angle multiplexed hologram sequentially. And since, all the recorded holograms have an identical image, the cardholder will not see the transition between the holograms, rather they will see a continuous image that spans over a larger angle range. As discussed above in FIG. 2, in one embodiment, when angle multiplexing, the holographic recording medium is rotated relative to the incident laser beams, which is the same as changing the beam angle relative to the holographic recording medium, for example, a holographic film. In another embodiment, one beam angle is changed, keeping all other beam angles and holographic recording medium angle constant. This rotation has the effect of changing the orientation of the index pattern orientation relative to the holographic film. The planes of index change, for plane wave holograms, change their orientation relative to the holographic recording medium, as the holographic recording medium is angle multiplexed. There is no actual limit on how many holograms can be angle multiplexed into a thick holographic film. However an increase in the number of angle multiplexes may cause a decrease in the overall brightness of the holograms. Typically, a hologram is formed by a change in the refractive index of the material. As more holograms are added, each hologram uses the available refractive index change to form the corresponding interference patterns and form a hologram. The interference fringes that form the hologram do not overlap exactly, because either the holographic recording medium is rotated or the beam geometry is being changed during angle multiplexing. Therefore, many holograms may be overlapped in the same volume, with each hologram sharing the available index change. There is however a practical limit which depends on the thickness of the holographic recording medium, the available index change, and the type of image that is being recorded. Since for different applications the brightness requirements may be different, the maximum number of angle multiplexed holograms that can be written in a defined volume may be dependent on the application.

As used herein the phrase “defined volume” means the volume of the holographic recording medium in which the hologram is recorded. The width of the defined volume is defined by the width of the two light beams that are interacting together to record the hologram. The depth of the defined volume is defined by the front surface and back surface of the holographic recording medium, but could also be a smaller localized sub region of the entire thickness of the holographic recording medium.

Referring to FIG. 8, a method 800 of recording a hologram (not shown in figure) is provided. A signal beam 810 and a reference beam 812 are incident on a holographic recording medium 814. The hologram is recorded in a defined volume in the holographic recording medium 814. The defined volume in the holographic recording medium has a width 816. The defined volume in the holographic recording medium has a depth 818 defined by a front surface 820 and a back surface 822. The width 816 of the defined volume is defined by the width of the signal beam 810 and the reference beam 812. In the embodiment depicted in FIG. 8, the signal beam 810 and the reference beam 812 are both long coherence laser beams. The dotted lines 824 and 826 represent the coherence length of the lasers functioning as the signal beam 810 and the reference beam 812 respectively. The coherence length of the lasers 824 and 826 are greater than the width 816 of the holographic recording medium 814. As a result, the hologram (not shown in figure) is recorded throughout the width 816 of the holographic recording medium 814 in the region 828.

In one embodiment, the authentication hologram is recorded in a thin layer of the holographic recording medium. As used herein the phrase “thin layer” means a layer of the holographic recording medium thinner than the overlap of the signal beam and the reference beam. In one embodiment, the authentication hologram recorded in a thin layer of the holographic recording medium is viewed by a hologram reader from different angles. In another embodiment, the authentication hologram recorded in a thin layer of the holographic recording medium is viewed by a human eye from different angles.

In one embodiment, the holographic recording medium in the device has a thickness in a range of about 5 micrometers to about 600 micrometers; wherein the authentication hologram is recorded throughout the thickness of the holographic recording medium.

In one embodiment, the holographic recording medium is used for overt applications. As used herein, the phrase “overt holograms” can be defined as holograms that are bright and easily viewable in ambient light by a human eye or a hologram reader. An overt hologram may include a two dimensional image, a three dimensional image, text, animation, company logo, serial number, or a manufacturing tracking number. A large view angle may be achieved by recording the holograms using a thin substrate as the holographic recording medium. In one embodiment, an overt hologram may be viewable in normal room light, without the aid of any special lighting or special training for the viewer to view the hologram. In one embodiment, the overt hologram has a large view angle ranging from about 5 degrees to about 20 degrees. The large view angle enables the hologram to be easily visible and easily locatable on the holographic recording medium. In one embodiment, the holographic recording medium used for recording the holograms has a thickness in a range of from about 5 micrometers to about 600 micrometers. As mentioned above, there is no actual limit to how many holograms can be angle multiplexed in a thin substrate, however there is a practical limit. As discussed above, each hologram that is angle multiplexed uses some of the available index change in the material. Because the material is thinner, each angle multiplexed hologram uses the available index change and thereby there is a depletion in the available index change. Therefore, higher the number of angle multiplexed holograms dimmer the appearance of the overall holographic device. In various embodiments, the application will define the necessary brightness, which will in turn define the number of allowable angle multiplexed holograms.

In one embodiment, the authentication hologram is artificially truncated. As used herein the term “artificial truncation” means recording a hologram in a thin portion of a thick holographic recording medium. In one embodiment, the authentication hologram is artificially truncated by recording a hologram using light having a limited coherence length. The coherence length represents the distance over which the two beams can interfere with each other and form a hologram. Typically, with a single wavelength laser, the coherence length is measured in meters, however it is possible to artificially decrease the coherence length of the laser so that it is measured in millimeters. As a result, a thin hologram can be written with a thick sample by adjusting the coherence length of the laser, and design the beam geometry such that the beams will only be coherence with each other in a narrow region of the material.

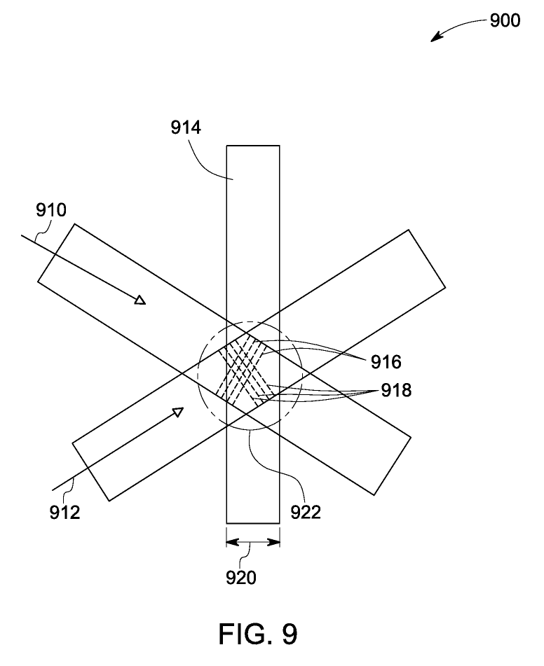

Referring to FIG. 9, a method 900 of recording a hologram (not shown in figure) is provided. A signal beam 910 and a reference beam 912 are incident on a holographic recording medium 914. In the embodiment described in FIG. 9, the signal beam 910 and the reference beam 912 are both long coherence laser beams. The dotted lines 916 and 918 represent the coherence length of the lasers functioning as the signal beam 910 and the reference beam 912 respectively. The holographic recording medium has a thickness 920. The coherence length of the lasers 916 and 918 are smaller than the thickness 920 of the holographic recording medium 914. As a result, the hologram (not shown in figure) is recorded in a small portion 922 of the thickness 920 of the holographic recording medium 914.

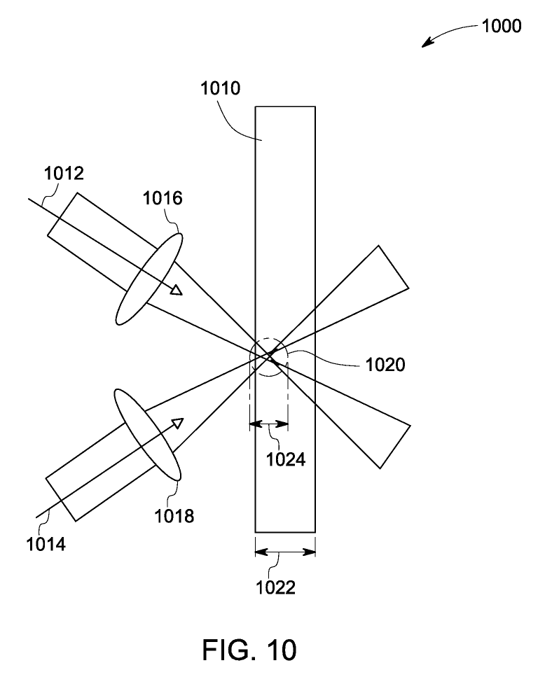

In one embodiment, the authentication hologram is artificially truncated by limiting interaction region of the incident light with the holographic recording medium by limiting focus region of the signal beam and the reference beam. The interaction region of the incident light with the holographic recording medium by focusing the signal beam and reference beam to small spots. When the focused spots are overlapped, they form a hologram in the overlap region. The selection of the focusing lens and initial beam size determines the size of the overlap region, which in turn determines the thickness of the hologram. Referring to FIG. 10, a method 1000 of recording a hologram (not shown in figure) is provided. A signal beam 1010 and a reference beam 1012 are incident on a holographic recording medium 1014. In the embodiment described in FIG. 10, focusing lenses 1016 and 1018 are placed in on the signal beam 1010 and the reference beam 1012 respectively, forcing the laser beam to focus on a small spot 1020 thereby limiting the interaction region of the incident light with the holographic recording medium. The hologram (not shown in figure) is formed at the point where the signal beam 1010 and the reference beam 1012 interfere. The holographic recording medium has a thickness 1022. Since the focusing lenses 1016 and 1018 direct the laser beams to only a thin region 1024 of the entire thickness of the holographic recording medium 1014 the hologram (not shown in figure) is recorded only in the thin region 1024 of the holographic recording medium 1014.

As mentioned above, in one embodiment, the holographic recording medium comprises an optically transparent plastic material and a photochemically active dye. For example, the holographic recording medium is a dye doped thermoplastic material. The dye-doped material undergoes a chemical change when exposed to light causing a change in the refractive index of the dye doped thermoplastic material, throughout the volume of the dye doped thermoplastic material. The refractive index change makes it possible to capture and record the interference fringes generated by the two beams of light that are incident on the dye doped thermoplastic material. These interference fringes form the hologram that is recorded in the dye doped thermoplastic material.

In certain embodiments, the dye doped thermoplastic material by virtue of being a thermoplastic, has certain processing advantages over competitive holographic materials. Using dye doped thermoplastic films helps to avoid or minimize the post processing involving wet chemistry processing. Further, the hologram may be viewed immediately after the hologram is recorded. Furthermore, the dye-doped thermoplastic materials may be used as part of a product itself, with reflection/transmission holograms written into the bulk of the part. The dye-doped thermoplastic materials may also be extruded or cast into thin films that can be laminated, hot pressed, or shrink-wrapped onto a product.

In some embodiments, the dye-doped thermoplastic materials used for forming the holographic storage medium comprise a thermoplastic material and a dye material possessing narrowband optical properties. Typically, the dye material is selected and utilized on the basis of several important characteristics including the ability to change the refractive index of the dye material upon exposure to light; the efficiency with which the light creates the change; and the separation between the maximum absorption of the dye and the desired wavelength or wavelengths to be used for writing and reading the image. In certain embodiments, the thermoplastic material utilized may comprise any thermoplastic having sufficient optical quality, for example, low scatter, low birefringence, and negligible losses at the wavelengths of interest, to render the data in the holographic storage material readable. Furthermore, the substrate should be capable of withstanding the processing parameters, such as for example, inclusion of the dye and application of any coating or subsequent layers, and molding into final format and subsequent storage conditions. Suitable materials that may be employed as the thermoplastic material include, in one embodiment, thermoplastics with glass transition temperatures of greater than or equal to about 100 degrees Celsius. In another embodiment, the glass transition temperature of the thermoplastics is greater than or equal to about 150 degrees Celsius. In yet another embodiment, the glass transition temperature of the thermoplastics is greater than or equal to about 200 degrees Celsius. Suitable examples of thermoplastics include but are not limited to, amorphous and semi-crystalline thermoplastic materials and blends selected from polycarbonates, polyetherimides, polyvinyl chloride, polyolefins (for example linear and cyclic polyolefins including polyethylene, chlorinated polyethylene and polypropylene), polyesters, polyamides, polysulfones (for example hydrogenated polysulfones), polyimides, polyether sulfones, acrylonitrile butadiene styrene resins, polystyrenes (for example hydrogenated polystyrenes, syndiotactic and atactic polystyrenes, polycyclohexyl ethylene, styrene-co-acrylonitrile, and styrene-co-maleic anhydride), polybutadiene, polyacrylates (for example, polymethylmethacrylate (PMMA), and methyl methacrylate-polyimide copolymers), polyacrylonitrile, polyacetals, polyphenylene ethers (for example, those derived from 2,6-dimethylphenol and copolymers with 2,3,6-trimethylphenol), ethylene-vinyl acetate copolymers, polyvinyl acetate, ethylene-tetrafluoroethylene copolymer, aromatic polyesters, polyvinyl fluoride, polyvinylidene fluoride, and polyvinylidene chloride.

In various embodiments, the dye materials utilized in the dye-doped thermoplastic materials are organic dyes which undergo an irreversible chemical change upon exposure to certain “write” wavelengths of light which shifts the absorption band exhibited by the dye to a lower wavelength, causing a refractive index change. In certain embodiments, photochemically active narrowband dyes may be employed. The photoproduct or photoproducts which result from interaction of the dye with light having the “write” wavelength typically exhibits an absorption spectrum (spectra) which is entirely different from that exhibited by the dye prior to irradiation. The irreversible chemical change in the dye produced by interaction with light of the write wavelength produces a corresponding change in the molecular structure of the dye, thereby producing a “photoproduct” which may be a cleavage-type photoproduct or a rearrangement type photoproduct. The modification to the structure of the dye molecule and concurrent changes in the light absorption properties of the photoproduct(s) relative to the starting dye produces a significant change in refractive index within the substrate that can be observed at a separate “read” wavelength (i.e., the reference beam). The narrowband dye materials utilized according to the present disclosure also tend to have strong optical characteristics due to conservation of oscillator strength, i.e., because the absorption is localized to a narrow spectral region, the magnitude of the absorption is stronger as the area under the curve (the oscillator strength) is conserved. Suitable examples of dyes include nitrostilbene and nitrostilbene derivatives such as 4-dimethylamino-2′,4′-dinitrostilbene, 4-dimethylamino-4′-cyano-2′-nitrostilbene, 4-hydroxy-2′,4′-dinitrostilbene, and 4-methoxy-2′,4′-dinitrostilbene. These dyes have been synthesized and optically induced rearrangements of such dyes have been studied in the context of the chemistry of the reactants and products as well as their activation energy and entropy factors in J. S. Splitter and M. Calvin, “The Photochemical Behavior of Some o-Nitrostilbenes,” J. Org. Chem., vol. 20, pg. 1086 (1955). Furthermore, recent work has focused on using the refractive index modulation that arises from these optically induced changes to write waveguides into polymers doped with the dyes. McCulloch, I. A., “Novel Photoactive Nonlinear Optical Polymers for Use in Optical Waveguides,” Macromolecules, vol. 27, pg. 1697 (1994).

The holographic recording media may also comprise a mixture of a photoactive material, a photosensitizer, and organic binder material, wherein the photoactive material undergoes a change in color upon reaction with the photosensitizer. Suitable materials for use as the photosensitive materials include but are not limited to, anthraquinones and their derivatives; croconines and their derivatives; monoazos, disazos, trisazos and their derivatives; benzimidazolones and their derivatives; diketo pyrrole pyrroles and their derivatives; dioxazines and their derivatives; diarylides and their derivatives; indanthrones and their derivatives; isoindolines and their derivatives; isoindolinones and their derivatives; naphtols and their derivatives; perinones and their derivatives; perylenes and their derivatives; ansanthrones and their derivatives; dibenzpyrenequinones and their derivatives; pyranthrones and their derivatives; bioranthorones and their derivatives; isobioranthorone and their derivatives; diphenylmethane, and triphenylmethane type pigments; cyanine and azomethine type pigments; indigoid type pigments; bisbenzoimidazole type pigments; azulenium salts; pyrylium salts; thiapyrylium salts; benzopyrylium salts; phthalocyanines and their derivatives, pryanthrones and their derivatives; quinacidones and their derivatives; quinophthalones and their derivatives; squaraines and their derivatives; squarilyiums and their derivatives; leuco dyes and their derivatives, deuterated leuco dyes and their derivatives; leuco-azine dyes; acridines; di- and tri-arylmethane, dyes; quinoneamines; o-nitro-substituted arylidene dyes, aryl nitrone dyes, and combinations of such materials.

The photsensitizer is suitably a photoactivatable oxidant, a one photon photosensitizer, a two photon photosensitizer, a three photon photosensitizer, a multiphoton photosensitizer, an acidic photosensitizer, a basic photosensitizer, a salt, a dye, a free radical photosensitizer, a cationic photosensitizer, or a combination comprising at least one of the foregoing photo sensitizers. By way of non-limiting example, the photsensitizer may be a hexaarylbiimidazole compound, a semiconductor nanoparticle, a halogenated compound having a bond dissociation energy effective to produce a first halogen as a free radical of not less than about 40 kilocalories per mole, a sulfonyl halide, R—SO₂—X wherein R is a member of the group consisting of alkyl, alkenyl, cycloalkyl, aryl, alkaryl, and aralkyl and X is chlorine or bromine, a sulfenyl halide of the formula R′—S—X′ wherein R′ and X′ have the same meaning as R and X, a tetraaryl hydrazine, a benzothiazolyl disulfide, a polymethacrylaldehyde, an alkylidene 2,5-cyclohexadien-1-one, an azobenzyl, a nitroso, alkyl (TI), a peroxide, a haloamine, or a combination comprising at least one of the foregoing photosensitizer. The photosensitizer may also be an acetophenone, a benzophenone, an aryl glyoxalate, an acylphosphine oxide, a benzoin ether, a benzil ketal, a thioxanthone, a chloroalkyltriazine, a bisimidazole, a triacylimidazole, a pyrylium compound, a sulfonium salt, an iodonium salt, a mercapto compound, a quinone, an azo compound, an organic peroxide or a combination comprising at least one of the foregoing photosensitizers.

In various embodiments, the organic binder includes a thermoplastic polymer, a thermosetting polymer, or a combination of a thermoplastic polymer with a thermosetting polymer that is moldable or coatable. For example, the organic binder material may include a polyacrylate, a polymethacrylate, a polyester, a polyolefin, a polycarbonate, a polystyrene, a polyamideimide, a polyarylate, a polyarylsulfone, a polyethersulfone, a polyphenylene sulfide, a polysulfone, a polyimide, a polyetherimide, a polyetherketone, a polyether etherketone, a polyether ketone ketone, a polysiloxane, a polyurethane, a polyether, a polyether amide, or a polyether ester, or a combination thereof. The organic binder may also comprise a thermosetting polymer such as an epoxy, a phenolic, a polysiloxane, a polyester, a polyurethane, a polyamide, a polyacrylate, a polymethacrylate, or a combination comprising at least one of the foregoing thermosetting polymers. The holographic recording medium may also be a combination of a photochromic compound and a moldable or curable binder material as described above. Non-limiting examples of photochromic dyes are a diarylethene, a nitrone or a combination thereof. Specific diarylethene include, without limitation, diarylperfluorocyclopentenes, diarylmaleic anhydrides, and diarylmaleimides. Specific nitrones include, without limitation, α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-[2-(1,1-diphenylethenyl)]-N-phenylnitrone, α-[2-(1-phenylpropenyl)]-N-phenylnitrone, or the like, or a combination comprising at least one of the foregoing nitrones.

In one embodiment, the holographic recording medium may be incorporated as one of the layers of a multi-layer stack. A multi-layer stack may be prepared by placing a lamination pad on a carrier tray followed by placing a lamination plate on the lamination pad. The lay-up book (stack of individual sheets that will constitute finished laminated structure) is then stacked according to the desired construction onto the base lamination plate. One of these individual sheets is a holographic recording medium. The sheets may be bonded together using heat treatment or using an adhesive layer as known to one skilled in the art.

In another embodiment is provided a method. The method comprises the steps of providing a device comprising an authentication hologram recorded within a defined volume of a holographic recording medium, wherein the authentication hologram is configured to convey authentication information; wherein the authentication hologram comprises a plurality of related volumetric holograms recorded within the defined volume; and wherein the holographic recording medium comprises an optically transparent plastic material and a photochemically active dye.

In certain embodiments, the hologram in the holographic recording medium is fixed using a protective film. Typically the protective film laminated over the holographic film is capable of absorbing UV and blue light, of about 450 nanometers in wavelength. Absorbing UV and blue light will keep ambient light from erasing the hologram recorded in the holographic film since the protective film will prevent the absorption of wavelengths greater than 450 nanometers by the photosensitive dye in the holographic film. The protective film will also act as a UV blocking layer, which may be necessary in many device applications.

In yet another embodiment is provided a device comprising an authentication hologram recorded within a defined volume of a holographic recording medium; wherein the authentication hologram is configured to convey authentication information; wherein the authentication hologram comprises a plurality of substantially identical volumetric holograms recorded within the defined volume; wherein the authentication hologram appears substantially identical when the device is viewed by a hologram reader from different angles; and wherein the holographic recording medium comprises an optically transparent plastic material and a photochemically active dye.

In still yet another embodiment is provided a device comprising an authentication hologram recorded within a defined volume of a holographic recording medium; wherein the authentication hologram is configured to convey authentication information; wherein the authentication hologram comprises a plurality of related volumetric holograms recorded within the defined volume; wherein the authentication hologram appears as an animated sequence of images to a stationary observer; and wherein the holographic recording medium comprises an optically transparent plastic material and a photochemically active dye.

### EXAMPLES

### Example 1

### Preparation of a Dye

### Step A: Preparation of phenylhydroxylamine

Ammonium chloride (20.71 grams (g), 0.39 moles (m)), de-ionized water (380 milliliters), nitrobenzene (41.81 g, 0.34 mo), and ethanol (420 milliliters (ml), 95 percent) were added to a 1-liter, 3-neck round-bottom flask equipped with a mechanical stirrer, thermometer, and nitrogen inlet. The resultant reaction mixture was cooled to 15 degrees Celsius using an ice water bath. Zinc powder (46.84 g, 0.72 m) was added to the cooled mixture in portions, and over a period of about 0.5 hours while ensuring that the temperature does not exceed 25 degrees Celsius. After the complete addition of the zinc, the reaction mixture was warmed to room temperature. The warmed mixture was stirred for half an hour and was then filtered to remove zinc salt and unreacted zinc. The filter cake (i.e., the zinc salt) was first washed with hot water (about 200 milliliters) and then was washed with methylene chloride (about 100 ml). The filtrate was extracted with methylene chloride (about 100 ml). The methylene chloride layers (obtained from the filter cake wash and filtrate extract) are combined, washed with brine (about 100 ml), dried over sodium sulfate, and the methylene chloride is evaporated. The product is dried in a vacuum oven for about 24 hours to give 17.82 g of phenylhydroxylamine as a fluffy light yellow solid.

### Step B: Preparation of alpha-(4-dimethylamino)styryl-N-phenyl nitrone

To a 1 liter, 3-neck round-bottom flask equipped with a mechanical stirrer and a nitrogen inlet was added phenylhydroxylamine (27.28 g, 0.25 m), 4-dimethylaminocinnamaldehyde (43.81 g, 0.25 m) and ethanol (250 ml) resulting in a bright orange colored mixture. To the resultant mixture, methanesulfonic acid (250 microliters) was added using a syringe. The resultant mixture turned to a deep red color solution with the dissolution of all the solids. Within about five minutes an orange solid was formed. Pentane (˜300 ml) was added to the mixture to facilitate stirring. The solid was filtered and dried in a vacuum oven at 80 degrees Celsius for about 24 hours to give 55.91 g of alpha-(4-dimethylamino)styryl-N-phenylnitrone as a bright orange solid.

### Example 2

### Procedure for Preparing Solution Samples

About 2 milligrams (mg) of alpha-(4-dimethylamino)styryl-N-phenyl nitrone dye prepared in Example 1 was added to acetonitrile (100 ml). The resultant mixture was stirred for about 2 hours or until complete dissolution of the dye in the acetonitrile.

### Example 3

### Sample Evaluation—Solution Samples

Procedure for measuring Ultraviolet-Visible (UV-vis) spectra of the photochemically active dyes.

All spectra were recorded on a Cary/Varian 300 UV-vis spectrophotometer using solutions. Spectra were recorded in the range of about 300 nanometers to about 800 nanometers. Solution samples prepared in Example 3 using the alpha-(4-dimethylamino)styryl-N-phenyl nitrone dye prepared in Example 1 was taken in a 1 centimeter quartz cuvette and acetonitrile was taken as the blank solvent to be placed in the reference beam path for the UV-Vis measurement. The sample was exposed to an UV beam at 390 nanometers for one minute. The UV-Vis spectrum the sample was measured before and after exposure to UV light.

### Example 4

### Preparation of Dye—Polymer Mixture

Ten kilograms of pelletized polystyrene PS 1301 (obtained from Nova Chemicals) was ground to a coarse powder in a Retsch mill and dried in a circulating oven maintained at 80 degrees Celsius for 12 hours. In a 10 liter Henschel mixer, 6.5 kilograms of the dry polystyrene powder and 195 grams of alpha-(4-dimethylamino) styryl-N-phenylnitrone were blended to form a homogeneous orange powder. The powder was fed into a Prism (16 mm) twin-screw extruder at 185 degrees Celsius to give 6.2 kilograms of dark orange colored pellets with a dye content of about 3 weight percent. The conditions used for extruding are included in Table 1 below.

TABLE 1

| Extrusion Parameters | Values |
|---|---|
| Screw (revolutions per minute) | 300 |
| Feeder Rate (units) | 4.8-6.3 (at 50 percent) |
| Torque (percent) | 68-72 |
| Temp Zone 1 (degrees Celsius) | 160-200 |
| Temp Zones 2-9 (degrees Celsius) | 170-190 |

### Example 5

### Procedure for Preparing Molded Disc

The extruded pellets (5 kg) prepared in a manner as described in Example 4 were dried in vacuum oven at temperatures of nearly 40 degrees Celsius below the glass transition temperature of the polymer. Optical quality discs were prepared by injection molding blends (prepared as described above in Example 4) with a Sumitomo, SD-40E all-electrical commercial CD/DVD (compact disc/digital video disc) molding machine (available from Sumitomo Inc.). The molded discs had a thickness in a range from about 500 micrometers to about 1200 micrometers. Mirrored stampers were used for both surfaces. Cycle times are generally set to about 10 seconds. Molding conditions were varied depending upon the glass transition temperature and melt viscosity of the polymer used, as well as the photochemically active dye's thermal stability. The maximum barrel temperature was controlled to be in a range of from about 200 degrees Celsius to about 375 degrees Celsius. The molded discs were collected and stored in the dark. The conditions used for molding OQ (Optical Grade) polystyrene based blends of the photochemically active dyes are shown in Table 2.

TABLE 2

| | Polystyrene |
|---|---|
| Molding Parameters | Blend |
| Barrel Temperature (Rear) (degrees Celsius) | 205 |
| Barrel Temperature (Front) (degrees Celsius) | 200 |
| Barrel Temperature (Nozzle) (degrees Celsius) | 200 |
| Melt Temperature (degrees Celsius) | 200-250 |
| Mold Temperature (degrees Celsius) | 50-70 |
| Total cycle Time (sec) | 3-12 |
| Switch Point (inch) | 0.7 |
| Injection Transition (inch) | 0.2 |
| Injection Boost Pressure (psi) | 1100 |
| Injection Hold pressure (psi) | 400 |
| Injection Velocity (millimeters per second) | 60-150 |

### Example 6

### Procedure for Preparing Extruded Film

The extruded pellets (5 kg) prepared in a manner as described in Example 4 were dried in vacuum oven at temperatures of nearly 40 degrees Celsius below the glass transition temperature of the polymer. Optical quality film was prepared by extruding blends (prepared as described above) with a Welex 1¼″ Extruder and Film Line (available from Welex Inc.). The extruded films had a thickness in a range from about 20 micrometers to about 250 micrometers. Mirrored rollers were used for both surfaces. Extrusion conditions were varied depending upon the glass transition temperature and melt viscosity of the polymer used, as well as the photochemically active dye's thermal stability. The maximum barrel temperature was controlled to be in a range of from about 200 degrees Celsius to about 375 degrees Celsius. The extruded films were collected and stored in the dark. The conditions used for molding OQ (Optical Grade) polystyrene based blends of the photochemically active dyes are shown in Table 3.

TABLE 3

| | Polystyrene |
|---|---|
| Extrusion Parameters | Blend |
| Die Temperature (degrees Celsius) | 200 |
| Die Adaptor Temperature (degrees Celsius) | 200 |
| Barrel Temperature (Zone 1) (degrees Celsius) | 200 |
| Barrel Temperature (Zone 2) (degrees Celsius) | 200 |
| Barrel Temperature (Zone 3) (degrees Celsius) | 200 |
| RPM | 10 |
| Torque (amps) | 2.25 |
| Die Pressure (psi) | 1650 |
| Throughput | Flood |
| Roll SP. Set | 7.5 |
| Nip Follow | 1:1 |

### Example 7

### Procedure for Lamination Films

Dye-doped polymer films obtained from solvent casting or extrusion, were laminated in a multi-layer stack using Lauffer LCL 40-70/2 Laminator. The films obtained in Example 7 were dried in vacuum oven at temperatures of nearly 40 degrees Celsius below the glass transition temperature of the polymer. A multi-layer stack was prepared by placing a lamination pad on a carrier tray followed by placing a lamination plate on the lamination pad. The lay-up book (stack of individual sheets that will constitute finished laminated structure) was stacked according to the desired construction onto the base lamination plate. In this Example, 4 sheets of SD814 Lexan film (available from SABIC Innovative Plastics; each sheet having a thickness of 4 mils) were stacked together were first stacked together. This was followed by a holographic film (4 mils thick) and 3 sheets of SDAB14 Lexan film (4 mils thick) to form the lay-up book. A top lamination plate was placed over the lay-up book and aligned in place to evenly distribute pressure through the stack. A top lamination pad was placed on top of the final lamination plate. A Lauffer laminator was pre-heated to 200 degrees Celsius and the prepared multi-stack layer set-up was placed in the laminator. The temperature was held at 200 degrees Celsius for 20 minutes at a pressure of 90 Newtons per square meter. This was followed by cooling down the Lauffer laminator to 20 degrees Celsius at a pressure of 250 Newtons per square meter and maintained under these conditions for 40 minutes. The resultant laminated structure having a thickness of was 75 micrometers was removed and stored in dark.

### Example 8

### Procedure for Preparing Solvent Cast Samples

1 g of polystyrene pellets was dissolved in 10 milliliters of methylene chloride and stirred for about 2 hours or till the polystyrene pellets were completely dissolved in the methylene chloride. (4-dimethylamino)styryl-N-phenyl nitrone (50 milligrams) was added to the polymer solution and stirred for about 2 hours or till the nitrone was completely dissolved in the methylene chloride. Solvent cast samples were made by pouring the dye-polystyrene solution inside a metal ring (5 centimeter radius) resting over a glass substrate. The assembly of the metal ring placed over the glass substrate was placed over a hot plate maintained at a temperature of about 40 degrees Celsius. The assembly was covered with an inverted funnel to allow slow evaporation of methylene chloride. Dried dye-doped polystyrene films were recovered after about 4 hours. The dye-doped polystyrene films contained 5 weight percent of the dye.

### Example 9

### Method of Use—Procedure for Recording of the Hologram

For recording of the hologram at either 532 nanometers or 405 nanometers, both the reference beam and the signal beam were incident on the test sample at oblique angles of 45 degrees. The sample was positioned on a rotary stage, which was controlled by a computer. Both the reference and the signal beams had the same optical power and were polarized in the same direction (parallel to the sample surface). The beam diameters (1/e 2) were 4 millimeters. A color filter and a small pinhole were placed in front of the detector to reduce optical noise from the background light. A fast mechanical shutter was placed in front of the laser controls the hologram recording time. In the 532 nanometers setup, a red 632 nanometers beam was used to monitor the dynamics during hologram recording. The recording power for each beam varied from 1 milliWatt to 100 milliWatt and the recording time varied from 10 milliseconds to about 5 seconds. The diffracted power from a recorded hologram was measured from a Bragg detuning curve by rotating the sample disc by 0.2 to 0.4 degrees. The reported values are not corrected for reflections off the sample surface. The power used to readout the holograms was two to three orders of magnitude lower than the recording power in order to minimize hologram erasure during readout. Results of the diffraction efficiencies of the dye prepared in Example 1 that were used for preparing the discs and films in Examples 7-9 are included in Table 4 below.

TABLE 4

| | | | Diffraction |
|---|---|---|---|
| | Thickness | Dye Loading | Efficiency at red |
| Sample | (mm) | (weight percent) | (Uncorrected) |
| Molded disc | 0.6 | 3 | 46 |
| Extruded film | 0.2 | 3 | 20 |
| Solvent Cast film | 0.1 | 5 | 45 |
| Laminated film | 0.15 | 5 | 23 |

### Example 10-14

### Method of Use—Procedure for Recording of the Authentication Hologram

In both Example 10 and Example 11a similar method is employed to record the holograms. The difference in the two examples lies in the thickness of the holographic recording medium employed. The holographic recording medium employed was a holographic film prepared in accordance with the method described in Example 6. A signal beam and a reference beam were incident over a holographic recording medium and were aligned in a manner such that they overlapped in the holographic recording medium. The dimensions of the overlap region of the two beams within the holographic recording medium employed in Examples 10 and 11 and the number of holograms recorded are provided in Table 5 below. The signal beam and the reference beam both included a beam with a Gaussian intensity profile. The two beams were incident on the holographic recording medium for about 30 seconds. After recording, the holograms were read by using the reference beam that was used during the recording process. The image of the hologram was captured using a CCD camera. The brightness of the hologram was measured by focusing into optical power detectors from ThorLabs, part number PDA36A. The sample was then removed from the hologram recording system, and the hologram viewed with eye in ambient light. Since the signal and the reference beams were both Gaussian in intensity profile and circular in dimension, the recorded holograms looked like brightly colored round spots recorded in the holographic material, the same size as the incident beams used during recording. The holograms were viewable over a large range of angles by an unaided eye and by an hologram reader.

TABLE 5

| | | | | Number of |
|---|---|---|---|---|
| | Thickness in | Width in | Length in | holograms |
| EXAMPLE | micrometers | millimeters | millimeters | recorded |
| 10 | 20 | 4 | 4 | 1 |
| 11 | 30 | 4 | 4 | 1 |

Example 12 provides a method for recording a plurality of holograms in a holographic recording medium.

The method used to recorded the holograms in this example was similar to the method used in Example 10 above except that 100 identical holograms were written into a 100 micrometer thick, 4 millimeter wide and 4 millimeter long holographic recording medium. A signal beam and a reference beam were incident over the holographic recording medium in manner such that the beams were aligned so that they overlap on the holographic recording medium. The signal beam included an image and the reference beam included a uniform beam. Each individual image was recorded sequentially, one at a time. After each image recording, the holographic recording medium was rotated by 0.5 degrees, and the next image was recorded. This process of recording and then changing the angle of the holographic recording medium was repeated for all 100 images. To read the images, the reference beam used during the recording process was used to reconstruct the holograms. A CCD camera was used to read the hologram reconstructed by the reference beam. In addition a hand held light source, like a flashlight, was used to view the holograms. By rotating the sample relative to the light source, all of the recorded images were visible to a viewer. The effect of recording 100 identical images into a 100 micrometer holographic film enabled the hologram to be viewed over a range of about 30 degrees to about 40 degrees as described in FIG. 2 above.

Example 13 provides a method for recording a plurality of holograms in a holographic recording medium.

The method used in Example 13 is similar to Example 12 with the exception of the type of images that were recorded. 100 slightly different holograms were written into a 100 micrometer thick, 4 millimeter wide and 4 millimeter long holographic recording medium. The images used to write the holograms in Example 13 were slightly different prospective views of a person's face. Each of these facial images were recorded at a slight different angular position relative to each other. When the hologram was viewed, rotation of the sample enabled the viewer to see different prospective views of the person's face recorded into the holographic recording medium, thus providing a simulated three dimensional appearance. The resultant hologram provided a biometric feature (image) viewable over a large range of angles by an unaided eye or a hologram reader.

Example 14 provides a method for recording a plurality of holograms in a holographic recording medium.

The method used in Example 14 is similar to Example 12 with the exception of the type of images that were recorded. 100 different images were written into a 100 micrometers thick, 4 millimeters wide and 4 millimeters long holographic recording medium. The images employed were totally different. When the hologram was viewed, rotation of the sample enabled the viewer to observe an animated sequence of images rather than a static image. The resultant hologram provided a perspective of a moving object as described in FIG. 3 above.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A device comprising:
an authentication hologram recorded within a defined volume of a holographic recording medium;
wherein the authentication hologram is configured to convey authentication information;
wherein the authentication hologram comprises a plurality of related volumetric holograms recorded within the defined volume; and
wherein the holographic recording medium comprises an optically transparent plastic material and a photochemically active dye.

2. The device according to claim 1, wherein the plurality of related volumetric holograms are substantially identical.

3. The device according to claim 2, wherein the authentication hologram is viewed by a hologram reader from different angles.

4. The device according to claim 2, wherein the authentication hologram is viewed by a human eye from different angles.

5. The device according to claim 1, wherein at least one hologram of the plurality of related volumetric holograms is optically encoded.

6. The device according to claim 5, wherein the authentication hologram is viewed by a hologram reader from different angles.

7. The device according to claim 5, wherein the authentication hologram is viewed by a human eye from different angles.

8. The device according to claim 1, wherein the authentication hologram appears as an animated sequence of images to a stationary observer.

9. The device according to claim 8, wherein the authentication hologram is viewed by a hologram reader from different angles.

10. The device according to claim 8, wherein the authentication hologram is viewed by a human eye from different angles.

11. The device according to claim 1, wherein the holographic recording medium in which the authentication hologram is recorded has a thickness in a range of about 5 micrometers to about 1200 micrometers.

12. The device according to claim 1, wherein the authentication hologram is recorded in a thin layer of the holographic recording medium.

13. The device according to claim 12, wherein the authentication hologram is viewed by a hologram reader from different angles.

14. The device according to claim 12, wherein the authentication hologram is viewed by a human eye from different angles.

15. The device according to claim 12, wherein the holographic recording medium in the device has a thickness in a range of about 5 micrometers to about 600 micrometers; wherein the authentication hologram is recorded throughout the thickness of the holographic recording medium.

16. The device according to claim 1, wherein the authentication hologram is artificially truncated.

17. The device according to claim 16, wherein the authentication hologram is viewed by a hologram reader from different angles.

18. The device according to claim 16, wherein the authentication hologram is viewed by a human eye from different angles.

19. The device according to claim 16, wherein the holographic recording medium in the device has a thickness, and a part of the thickness in which the authentication hologram is artificially truncated is in a range of about 5 micrometers to about 600 micrometers.

20. The device according to claim 1, wherein the device comprises a credit card, an identification card, hotel room key, an access key, a passport, a bill of currency, an authentication tag, a shipping manifest, a bill of lading, or an electronic information storage device.

21. A method comprising,
providing a device comprising an authentication hologram recorded within a defined volume of a holographic recording medium,
wherein the authentication hologram is configured to convey authentication information;
wherein the authentication hologram comprises a plurality of related volumetric holograms recorded within the defined volume; and
wherein the holographic recording medium comprises an optically transparent plastic material and a photochemically active dye.

22. The method according to claim 21, wherein the plurality of related volumetric holograms are substantially identical.

23. The method according to claim 22, wherein the authentication hologram is recorded within one or more volume elements of a holographic recording medium;
wherein the related volumetric holograms are recorded a plurality of times at different angles in the same volume element of the medium; and
wherein each time of the plurality of times the related volumetric holograms are recorded one on top of another in the same volume element of the holographic recording medium.

24. The method according to claim 21, wherein the authentication hologram is artificially truncated.

25. The method according to claim 24, wherein the authentication hologram is artificially truncated by recording a hologram using light having a limited coherence length.

26. The method according to claim 25, wherein the authentication hologram is artificially truncated by limiting interaction region of the incident light with the holographic recording medium by limiting focus region of the signal beam and the reference beam.

27. The method according to claim 21, wherein the authentication hologram appears as an animated sequence of images to a stationary observer.

28. The method according to claim 27, wherein the authentication hologram is recorded within one or more volume elements of a holographic recording medium in a manner such that the information recorded one on top of another in the same volume element of the medium is modulated to have a relationship.

29. The method according to claim 21, wherein the frequency spectrum of the hologram is low enough to be not distorted by the reading wavelength; and wherein the reading wavelength is substantially different from the recording wavelength.

30. The method according to claim 21, wherein at least one hologram of the plurality of related volumetric holograms is optically encoded.

31. A device comprising:
an authentication hologram recorded within a defined volume of a holographic recording medium;
wherein the authentication hologram is configured to convey authentication information;
wherein the authentication hologram comprises a plurality of substantially identical volumetric holograms recorded within the defined volume;
wherein the authentication hologram appears substantially identical when the device is viewed by a hologram reader from different angles; and
wherein the holographic recording medium comprises an optically transparent plastic material and a photochemically active dye.

32. A device comprising:
an authentication hologram recorded within a defined volume of a holographic recording medium;
wherein the authentication hologram is configured to convey authentication information;
wherein the authentication hologram comprises a plurality of related volumetric holograms recorded within the defined volume;
wherein the authentication hologram appears as an animated sequence of images to a stationary observer; and
wherein the holographic recording medium comprises an optically transparent plastic material and a photochemically active dye.
